(19) United States
(12) Patent Application Publication
(10) Pub. No.: US 2020/0352324 A1
(43) Pub. Date: Nov. 12, 2020

(54) Personal Pod Storage Unit

(71) Applicant: David Keller, Merrick, NY (US)

(72) Inventor: David Keller, Merrick, NY (US)

(21) Appl. No.: 16/407,299

(22) Filed: May 9, 2019

(51) Int. Cl. A47B 81/00; E06B 3/44; F21V 31/00; B60B 33/00

(52) U.S. Cl. CPC A47B 81/00; B60B 33/0002; F21V 31/005; E06B 3/4407

(57) ABSTRACT

A storage unit designed to help improve personal storage needs. This unit will allow for easy transport for the ease of uses. The unit enables users to move the storage unit from place to place because of the wheels and size. The size of the unit will allow users to move through standard door length and width. The unit will have the ability to be disassembled for ease of storage. It will also have the option of a door that can be pulled down from the top of the unit for secured storage. Inside the unit there are groves to allow for attachment of a hanger bars and placement of shelving. This storage unit can be airtight sealed with a airtight plastic bag attachment that is located on the base of the unit with a airtight zipper seal. When a user locks the unit door it will allow for a lever that will also lock the wheels for better security.

### BACKGROUND OF THE INVENTION

The present invention relates to an enclosed personal portable storage unit and, more particularly, to allow people to store items in an enclosed portable storage unit that is water, bug and rodent resistant on wheels.

The most important factors in storing item such as college dorm rooms or personal items for small housing material is the time and effort to wrap up and box up the items that are most important to you in a way that is equal to your own closet. This unit will be portable light in weight on wheels to allow the user to move the unit to a location for ease of packing and transportation.

Current devices do not allow for items to be stored in a water tight, bug resistant and rodent proof storage that is large and portable. Current devices also do not allow for doors that can be locked for security or to be able hang items and placement of storage.

As can be seen, there is a need for an improved of storage for many different usages that may be used for short or long periods of time for a particular use in a sealed environment.

### BRIEF DESCRIPTION OF THE DRAWINGS

FIG. 1 is an overall perspective view of a storage unit according to an exemplary embodiment of the present invention from the front;

FIG. 2 is a side perspective view of a of the storage unit with a built-in handle;

FIG. 3 is a top of the storage unit perspective view assembled from the inside showing the sliding door and its brackets, grove for the walls to make the unit water, bug and rodent resistance and the locking brackets of the storage unit;

FIG. 4 is an inside view of the base of an assembled storage unit that show the wall locking grooves, locking brackets, wheel locking level and the airtight zipper lock attachment in the present invention;

FIG. 5 is a top view of the walls that show the side attachment for each wall to connect to each other, as well as the locking brackets;

FIG. 6 is bottom view of the base that shows the wheels, wheel locking level and the wheel locking apparatus that locks the wheels;

FIG. 7 is an inside view of the wall that shows the built-in brackets for a hanger rod and the shelving placement. It also shows the locking brackets for the top and base of the unit;

FIG. 8 is a cross section view of the base of the storage unit that shows the groove for the walls placement to ensure water, bug and rodent resistance. As well as the airtight zipper lock attachment;

FIG. 9 is a cross section of the top attachment of the storage unit that shows the groove of the for the walls and the door brackets for the sliding door.

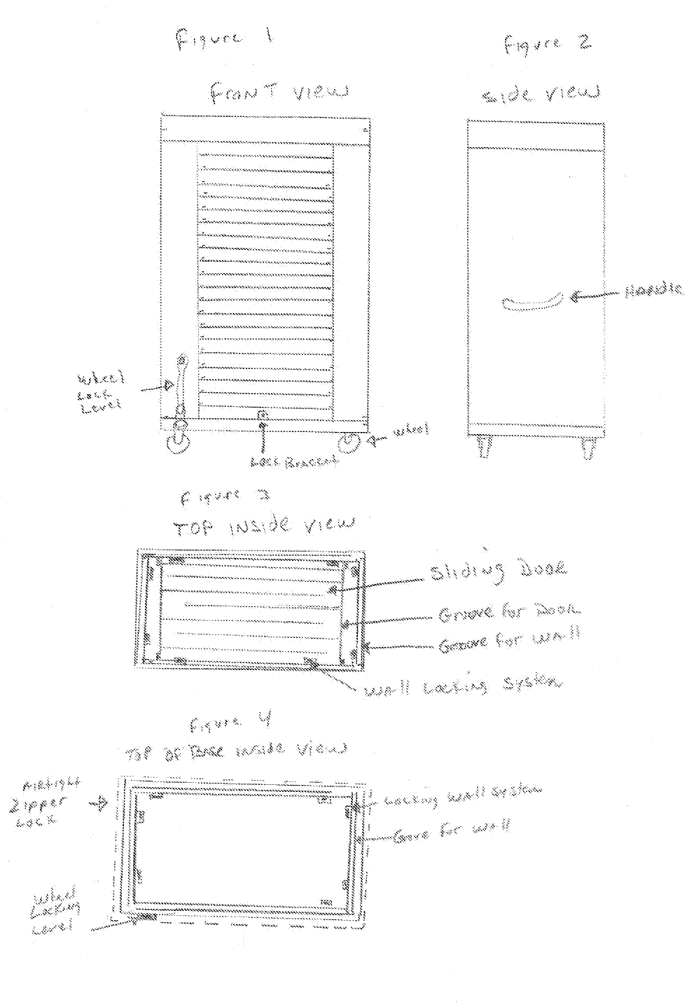

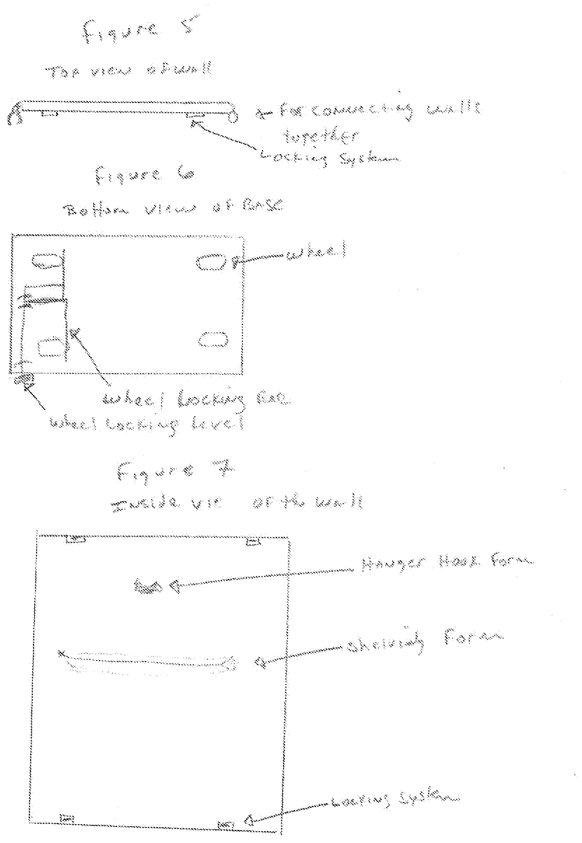

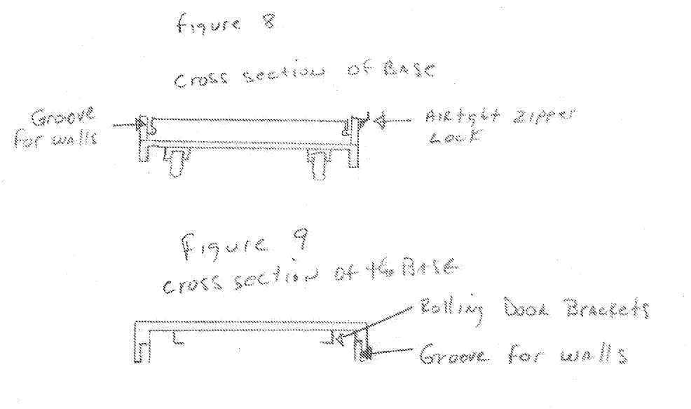

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a personal storage unit may have many uses to easily store and organize a person's items, for example. The storage unit can be moved to any location in a secured manner due to the wheels and locking system. The units can be adjusted for multiple uses with the built-in brackets for a hanger rod and or shelving that are included on the walls of the unit. The wall piece is designed to snap into place onto each other and the top and base on the storage unit. This will allow for a tight water, bug and rodent resistance for the protection of the items inside the storage unit.

The unit of the present invention can be securely lock with the sliding front door. This door would be made with a flexible design to allow for it to slide up and down through brackets inside the unit that will be ride in groves that will be placed on the inside of the front, top and the back for the walls for a tight secure fitting. There will be and locking bracket on the door and the base for locking the unit from others.

The unit will have a wheel locking system that will allow a user to lock the storage unit from moving. The wheel locking system is located on the base of the unit that will have a level, when pulled down the level will slide into the locking bracket whereas a lock can be placed on it for secure placement.

The storage unit will have an airtight zipper locking system built into the base of the unit to allow for an airtight plastic surrounding for an airtight storage protection. The plastic will be placed over the unit and secured with a four tied zipper ensuring the complete airtight seal completely around the storage unit. The zipper attachment is placed above the locking level for a secure seal.

Referring now to the Figures, they will show the wall attachment to each other, they can be slide into one other with a tongue and groove. The tongue and groove system will provide a tight seal for the resistance of water, bug and rodents. These walls will be able to snap into the top and base of the storage unit as shown on the figures.

The figure shows the cross sections of the top and base of the storage unit that provides for the grooves that the walls can snap into for the secure sealing of the unit.

It should be understood, of course, that the foregoing relates to exemplary embodiments of the invention and that modifications may be made without departing from the spirit and scope of the invention as set forth in the following claims.

What is claimed is:

1: A enclosed personal portable storage unit, comprising of;
A plastic in nature walls that are foldable and detachable with a tongue and groove system;
A top that is removable and secured to the walls with locking brackets on the inside;
A base that has wheels and is removable and able secured to the walls with locking brackets on the inside;
wherein the unit can be easy assembled.

2: The storage unit according to claim 1; wherein the top and bottom will have grooves in them for the walls to sit tightly within them for proper resistance to bugs, water and rodents. Wherein the walls will have grooves to connect to one other.

3: The storage unit according to claim 1; wherein the storage unit includes a rolling door attached to the top of the unit that can pull down for a secure enclosure for the items in side.

4: The storage unit according to claim 1; wherein the storage unit has an attachment inside to allow for hanging items such as a hanger rod or shelving.

5: The storage unit according to claim 1; wherein the storage unit has an attachment device on the outside wherein the locking level will line up with a locking device to securely lock the unit's wheels.

6: The storage unit according to claim 1; wherein the storage unit has an attachment groove device on the base to allow for a plastic surrounding to seal the unit in an airtight manner.

7: The sport training device that comprises of claims 1 and 2.

8: The sport training device that comprises of claims 1,2 and 3

9: The sport training device that comprises of claims 1,2,3 and 4.

10: The sport training device that comprises of claims 1,2,3, 4 and 5.

11: The sport training device that comprises of claims 1,2,3,4, 5 and 6.
